(19) United States
(12) Patent Application Publication
(10) Pub. No.: US 2008/0017038 A1
(43) Pub. Date: Jan. 24, 2008

(54) HIGH EFFICIENCY HVAC FILTER

(75) Inventor: Tien T. Wu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/459,128

(22) Filed: Jul. 21, 2006

(51) Int. Cl. B01D 53/04

(52) U.S. Cl. 96/154

(57) ABSTRACT

There is provided a pleated HVAC type filter containing a pleated filter media laminate of a melt blown nonwoven media containing layer and a nanofiber filter media layer. The melt blown nonwoven media containing layer has an upstream face and a downstream face, where the downstream face is laminated to the nanofiber filter media layer. The melt blown nonwoven media further has a very low basis weight of less than 30 grams/m² and a thickness of less than 1 mm, the filter media laminate, which includes supporting scrim layers, has a basis weight of less than 200 grams/m² and a thickness of less than 3 mm where the filter media laminate is pleated to a pleat density of at least 1 pleats/cm and has an initial pressure drop of less than 0.45 inches of water, a small particle efficiency, relative to 0.3 to 1.0 micron particles, of greater than 70 percent, the nanofiber filter media comprising a nanofiber web on a support backing, wherein the nanofibers have a diameter of less than 1.0 microns and an efficiency relative to 0.8 micron PSL particles of greater than 30 percent.

### BACKGROUND AND FIELD OF THE INVENTION

The present invention relates to high efficiency particulate HVAC filters.

The removal of some or all of the particulate material from air and gas streams over extended time periods is an often addressed need. For example, air intake streams to the cabins of motorized vehicles, air in computer disk drives, HVAC air, aircraft cabin ventilation, clean room ventilation, air to engines for motorized vehicles, or to power generation equipment; gas streams directed to gas turbines; and, air streams to various combustion furnaces, often include particulate material that needs to be constantly filtered or otherwise removed. All these applications and others not listed have very different particle removal needs, priorities and requirements. In the case of cabin air filters it is desirable to remove the particulate matter for comfort of the passengers and/or for aesthetics. In clean rooms extremely high particle removal is needed, often regardless of the pressure drop. In other instances, such as production gases or off gases from industrial processes or engines particle removal is desired but pressure drop is of a higher priority as high backpressure on pumps and other equipment could lead to equipment failure or injury to users and workers.

A general understanding of some of the basic principles and problems of air filter design can be understood by consideration of the following types of filter media: surface loading media; and, depth media. Each of these types of media has been well studied, and each has been widely utilized. Certain principles relating to them are described, for example, in U.S. Pat. Nos. 5,082,476; 5,238,474; and 5,364,456.

The “lifetime” of a filter is typically defined according to a selected limiting pressure drop across the filter. The pressure buildup across the filter defines the lifetime at a defined level for that application or design. Since this buildup of pressure is a result of particle load, for systems of equal efficiency a longer life is typically directly associated with higher capacity. Efficiency is the propensity of the media to trap, rather than pass, particulates. It should be apparent that typically the more efficient a filter media is at removing particulates from a gas flow stream, in general the more rapidly the filter media will approach the “lifetime” pressure differential (assuming other variables to be held constant). In HVAC systems there is the conflicting desire to obtain relatively high efficiencies and high loading capacities over extended lifetimes to avoid the need to be continuously replacing filters. With surface loading filters this generally is not possible unless the filter media is able to be periodically cleaned such as by backpulsing. With depth loading filters to obtain the necessary efficiencies it is often desired to charge the filter media, however charges will dissipate or be shielded over time making this solution often unsuitable for longer term applications such as those required for high efficiency filters (for example, MERV 12 and MERV 14 applications per ASHRAE Standard 52.2-1999).

Generally high efficiency long life particulate filtration is commonly desired in home, vehicle, office, health care, or critical manufacturing environments. With these uses frequent filter changeout is costly and/or sometimes missed. As such it is desirable to design a filter that can perform for extended periods of time with a minimum efficiency level coupled with the ability to maintain a relatively low pressure drop, particularly if filter changeout is missed.

### SUMMARY OF THE INVENTION

The invention is a pleated HVAC filter containing a pleated filter media laminate of a melt blown nonwoven media containing layer and a nanofiber filter media layer. The melt blown nonwoven media containing layer has an upstream face and a downstream face, where the downstream face is laminated to the nanofiber filter media layer. The melt blown nonwoven media further has a very low basis weight of less than 30 grams/m² and a thickness of less than 1 mm, the filter media laminate, which includes supporting scrim layers, has a basis weight of less than 200 grams/m² and a thickness of less than 3 mm where the filter media laminate is pleated to a pleat density of at least 1 pleats/cm and has an initial pressure drop of less than 0.45 inches of water, a small particle efficiency, relative to 0.3 to 1.0 micron particles, of greater than 70 percent, the nanofiber filter media comprising a nanofiber web on a support backing, wherein the nanofibers have a diameter of less than 1.0 microns and an efficiency relative to 0.8 micron PSL particles of greater than 30 percent.

### BRIEF DESCRIPTION OF THE DRAWINGS

FIG. 1 is a perspective view of a filter using multiple pleated filters of the present invention.

FIG. 2 is a side view of a pleated filter of the present invention.

FIG. 3 is a cutaway perspective view of the pleated filter media laminate of the present invention.

### DETAILED DESCRIPTION OF THE INVENTION

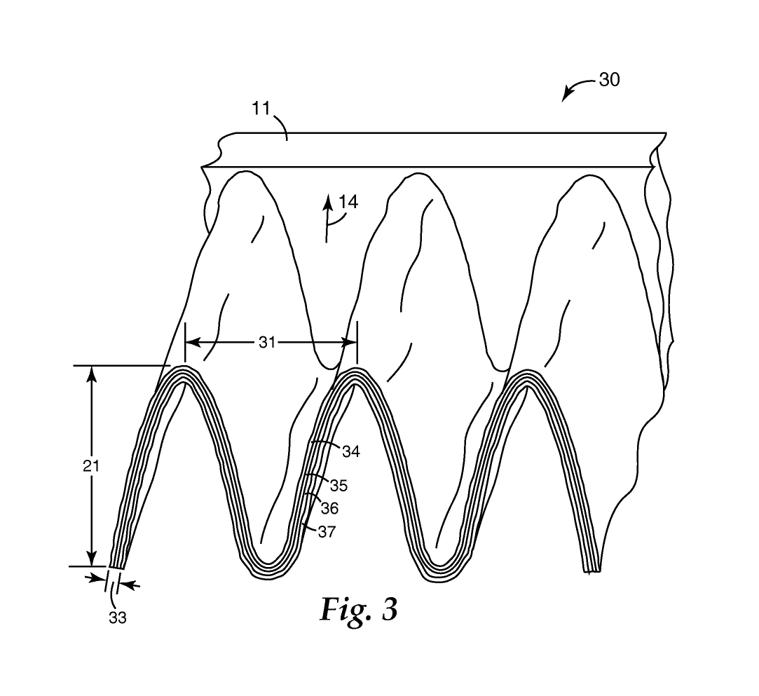

The pleated filter of the invention is a pleated filter media laminate designed for low cost use in HVAC applications. The pleated filter of the invention is formed from a filter media laminate that has a flat media pressure drop of less than 0.45 inches of water preferably less that 0.4 inches (measured as defined below). The filter media laminate should generally have a small particle efficiency (relative to 0.3 to 1.0 micron particles, as defined herein) of greater than 60 percent, preferably greater than 65 percent or 70 percent. The final filter comprising the pleated filter media laminate is designed for use in HVAC applications for use over an extended time period of up to 3 months, generally 3 to 24 months while maintaining a minimum average small particle efficiency of greater than 70 percent and preferably greater than 75 percent over the useful intended lifetime, while maintaining a pressure drop for the entire pleated filter of less than 0.45 inches of water (as defined below), preferably less than 0.40 or 0.35 inches or lower. The filter as shown in FIG. 3 comprises a pleated filter media laminate 30 of a specific melt blown nonwoven filter media containing layer (or layers) 36 and a nanofiber filter media containing layer 35 (or layers) arranged, such that the nanofiber media containing layer 35 is downstream 14 of the specific melt blown nonwoven filter media containing layer 36.

The specific melt blown nonwoven media can be formed of one or more melt blown webs, optionally with a support web, but will have an upstream face and a downstream face. The upstream face of the specific melt blown nonwoven media, in the filter media laminate, will be initially impacted by the particle laded air and will capture particles within the depth of the melt blown nonwoven filter media. Filtration efficiency can be initially enhanced by charging the melt blown web or webs to allow for electret particle capture. However the melt blown filter media will be such that over time its minimum efficiency is sufficient to provide the needed performance and particle holding capacity, when and if the electret charge dissipates for longer term use. The downstream face of the melt blown nonwoven filter media layer 36 is laminated to a nanofiber filter media layer 35. The nanofiber filter media layer 35 is designed to keep the filter performance relatively constant over longer term use without the need to back pulse or otherwise clean the filter. The specific combination prevents the surface loading nanofiber filter from increasing the pressure drop to unacceptable levels, which would make filter replacement necessary after relatively short term use. To allow for pleating to the desired level the filter media laminate should have a basis weight of less than 200 grams/m², preferably less than 150 grams/m². The filter media laminate also should have a thickness 33 of less than 3 mm, or less than 2 mm or 1.5 mm. This thin relatively low basis weight filter media laminate is then pleated to a pleat density of at least 1 pleats/cm or 1 to 5 pleats/cm or 2 to 5 pleats/cm and a pleat depth of from 0.5 to 10 cm or 1 to 5 cm. This provides the necessary filtration efficiency and loading capacity for long term HVAC use for the invention filter.

The specific melt blown filter media layer used generally has a flat media pressure drop of less than 0.4 inches of water and preferably less than 0.3 inches or even 0.2 inches (as defined below), a small particle efficiency (relative to 0.3 to 1.0 micron particles, as defined herein) of greater than 30 percent, preferably greater than 40 percent at a basis weight of less than 30 grams/m², preferably less than 25 grams/m² or less than 20 grams/m² with a thickness of less than 1 mm, preferably less than 0.6 mm. The melt blown filter media also is generally characterized by having an Effective Fiber Diameter (EFD, as calculated according to the method set forth in Davies, C. N., “The Separation of Airborne Dust and Particulates,” Inst. of Mech. Eng., London, Proceedings 1B, 1952.) of less than 6 microns, preferably less than 5 microns or 4.5 microns. This is a thin low basis weight melt blown web or laminate, however when combined with the nanofiber media on its downstream face provides a large loading capacity and consistent high performance filtration efficiency over time.

The nanofiber filter media layer is also relatively thin, generally comprising at least one nanofiber web on a support backing, wherein the nanofibers have a average diameter of less than 1.0 microns, preferably less than 0.5 microns or 0.3 microns. The nanofiber filter media generally has an efficiency relative to 0.8 micron PSL particles of greater than 30 percent or 40 percent.

A preferred melt blown media used is a melt blown web, which fibers are formed of a generally nonconductive polymer and optionally can be charged with a charge performance-enhancing additive. The polymer can be a nonconductive thermoplastic resin, that is, a resin having a resistivity greater than 10¹⁴ ohm-cm, more preferably 10¹⁶ ohm-cm. If charged, the polymer should have the capability of possessing a non-transitory or long-lived trapped charge. The polymer can be a homopolymer, copolymer or polymer blend. The preferred polymers include polyolefins; such as polypropylene, poly(4-methyl-1-pentene) or linear low density polyethylene; polystyrene; polycarbonate and polyester. The major component of the polymer or polymer blend is preferably polypropylene because of polypropylene's high resistivity, ability to form melt-blown fibers with diameters useful for the invention air filtration medium, satisfactory charge stability, hydrophobicity and resistance to humidity.

Performance-enhancing additives, as defined herein, are those additives that enhance the filtration performance of the electret filtration medium. Potential performance-enhancing additives include those described by Jones et al., U.S. Pat. No. 5,472,481 and Rousseau et al., WO 97/07272 (U.S. application Ser. No. 08/514,866), the substance of which are incorporated herein by reference in their entirety. The performance-enhancing additives include fluorochemical additives namely a thermally stable organic compound or oligomer containing at least one perfluorinated moiety, such as fluorochemical piperazines, stearate esters of perfluoroalcohols, and/or thermally stable organic triazine compounds or oligomers containing at least one nitrogen atom in addition to those of the triazine group or a hindered or aromatic amine compound; most preferably a compound containing a hindered amine such as those derived from tetramethylpiperidine rings. Preferably the hindered amine is associated with a triazine group. Alternatively, nitrogen or metal containing hindered phenol charge enhancers could be used such as disclosed in Nishiura, et al, U.S. Pat. No. 5,057,710, the substance of which is incorporated by reference in its entirety.

The polymer and performance-enhancing additive can be blended as solids before melting them, or melted separately and blended together as liquids. Alternatively, the additive and a portion of the polymer can be mixed as solids and melted to form a relatively additive-rich molten blend that is subsequently combined with the non-additive-containing polymer. The melt blown web can contain about 0.2 to 10 weight percent of the performance-enhancing additive; more preferably about 0.2 to 5.0 weight percent; and most preferably about 0.5 to 2.0 weight percent, based on the weight of the melt blown web.

With the melt blown web a molten blend is extruded through a melt blown fiber die onto a collecting surface and formed into a web of thermoplastic microfibers. The microfibers are integrally bonded each to the other at their crossover points either during the web formation process or after the web formation process. The melt blown webs can be made using melt-blowing processes and apparatuses that are well known in the art. Fiber melt-blowing was initially described by Van Wente, “Superfine Thermoplastic Fibers,” Ind. Eng. Chem., vol. 48, pp. 1342-46, (1956). In general, the melt-blowing process used to produce the present invention filter medium is conventional, however, the conditions are modified to produce fine fiber filter webs having effective fiber diameters (EFD's), as described above. The effective fiber diameter can be decreased by decreasing the collector to die distance, using a vacuum within a foraminous collector surface, lowering the polymer flow rate, or changing the air pressure, temperature or volume used to attenuate the melt streams exiting from the die. Also, the design of the die and attenuating air vanes can be varied such as changing the relative angle of the attenuating air, changing the distance between the die tip and the junction point of the attenuating air or changing the die orifice diameters and/or diameter-to-length ratios. These factors and others are discussed, for example, in WO 92/18677A (Bodaghi et al.). The fibers can be quenched, before being collected, by a cooling process such as water spraying, spraying with a volatile liquid, or contacting with chilled air or cryogenic gasses such as carbon dioxide or nitrogen.

Melt-blown fibers are collected as a nonwoven web on a rotating drum or moving belt. The collector to die distance is generally from 8 to 25 cm, preferably from 10 to 20 cm with the collector preferably being foraminous, such that it can be used with a vacuum to remove excess air.

Electrostatically charging the nonwoven web material before or after it has been collected can also be performed. Examples of electrostatic charging methods include those described in U.S. Pat. Nos. 5,401,446 (Tsai, et al.), 4,375,718 (Wadsworth et al.), 4,588,537 (Klaase et al.), and 4,592,815 (Nakao). This includes charging by corona discharge, applied electric fields or hydrocharging, such as described in U.S. Pat. No. 5,496,507 to Angadjivand et al. This charging method can be performed on a preformed web thereby avoiding the difficulties in forming charged fibers into a uniform web structure.

The material used to form charged melt blown webs is desirably substantially free of materials such as antistatic agents that could increase electrical conductivity or otherwise interfere with the ability of the article to accept and hold electrostatic charge. Additionally, the electret filter medium should not be subjected to unnecessary treatments such as exposure to gamma rays, UV irradiation, pyrolysis, oxidation, etc., that might increase electrical conductivity. Thus, in a preferred embodiment the electret filter medium is made and used without being exposed to gamma irradiation or other ionizing irradiation.

The nanofiber layer or layers of the invention filter comprise a random distribution of fine fibers, which can be bonded to form an interlocking net. The fine, or nanofiber, fibers can have a diameter of generally less than 1 micron and preferably from about 0.001 to 0.5 microns. Filtration performance by the nanofiber webs is obtained largely as a result of the fine fiber barrier to the passage of particulate. Structural properties of stiffness, strength, pleatability are provided by the substrates to which the fine nanofiber is adhered, which could be a separate backing or a face of the melt blown nonwoven filter media containing layer. The fine fiber interlocking networks have relatively small spaces between the fibers. Such interfiber spaces in the layer typically range, between fibers, of about 0.01 to about 25 microns or often about 0.1 to about 10 microns. The filter products comprise a fine fiber layer on a choice of appropriate low pressure drop but high strength substrate. The fine fiber adds less than 5 microns, often less than 3 microns of thickness. The fine fiber in certain applications adds about 1 to 10 or 1 to 5 fine fiber diameters in thickness to the overall fine fiber plus substrate filter media. These fine fiber filters can stop incident particulate from passing to the substrate or through the fine fiber layer and without the melt blown media can attain substantial surface loadings of trapped particles and rapidly form a dust cake on the fine fiber surface. For a short term this surface loading can maintain high initial and overall efficiency of particulate removal but will eventually unacceptable increase pressure drops in HVAC applications.

The polymer used to form the fine or nano fiber can be an additive polymer, a condensation polymer or mixtures or blends thereof for example a first polymer and a second, but different polymer (differing in polymer type, molecular weight or physical property) that is conditioned or treated at an elevated temperature. The polymer blend can be reacted and formed into a single chemical specie or can be physically combined into a blended composition by an annealing process. Materials for use in the blended polymeric systems include nylon 6; nylon 66; nylon 6-10; nylon (6-66-610) copolymers and other linear generally aliphatic nylon compositions. Also a single polymeric material can be combined with an additive such as nylon polymers, polyvinylidene chloride polymers, polyvinylidene fluoride polymers, polyvinylalcohol polymers and, in particular, those listed materials when combined with strongly oleophobic and hydrophobic additives that can result in a fine or nanofiber with the additive materials formed in a coating on the fine fiber surface. Again, blends of similar polymers such as a blend of similar nylons, similar polyvinylchloride polymers, blends of polyvinylidene chloride polymers are useful.

The fine or nano fiber materials are formed on and adhered to the specific melt blown nonwoven filter media containing layer or a separate high strength and low pressure drop substrate which could be natural fiber and synthetic fiber substrates however are preferably spunbond synthetic fabrics which generally are very low pressure drop and have a basis weight of from 40 to 150 g/m².

A fine or nano fiber filter media can be formed by an electrostatic spinning process. A fine fiber forming polymer solution is pumped to a rotary type emitting device or emitter. The emitter generally consists of a rotating portion with a plurality of holes spaced around the periphery. The rotating portion rotates in the electrostatic field and droplets of the solution are accelerated by the electrostatic field toward the support media on a grid through which air can pass. A high voltage electrostatic potential is maintained between the emitter and the grid by means of a suitable electrostatic voltage source and connections between the grid and emitter. The electrostatic potential between the grid and the emitter imparts a charge to the polymer coming from the emitting device which causes liquid to be emitted therefrom as thin fibers which are drawn toward the grid where the fibers arrive and are collected on the supporting substrate. In the case of a polymer in solution, solvent is evaporated off the fibers during their flight to the grid. The fine or nano fibers bond to the substrate fibers at the grid.

The invention filter media laminate if formed as separate laminates or layers can be laminated by adhesives, heat bonding, ultrasonics or the like.

The invention filter laminate can be corrugated into pleated structures by standard pleating methods and equipment. This pleatability and handleability is due to the relatively high strength of the invention melt formed thermoplastic fiber webs and the nanofiber support web. Generally the invention filter laminate have a tensile strength sufficient to be self-supporting, which generally is a tensile strength in at least one direction of at least about 5 Newtons, preferable at least 10 Newtons.

### EXAMPLES

Preparation of the Filter Media Laminate Materials

### Filter Laminate 1 (Hereinafter Below “Web”)

### Web Preparation

A polypropylene based melt blown microfiber (BMF) web was prepared using a melt blowing process similar to that described, for example, in Wente, “Superfine Thermoplastic Fibers,” in Industrial Engineering Chemistry, Vol. 48, pages 1342 et seq (1956) or in Report No. 4364 of the Naval Research Laboratories, published May 25, 1954, entitled “Manufacture of Superfine Organic Fibers” by Wente et al. The extruder had ten temperature control zones that were maintained at 400° F. (204° C.), 450° F. (232° C.), 500° F. (260° C.), 540° F. (282° C.), 575° F. (302° C.), 610° F. (321° C.), 640° F. (338° C.), 665° F. (352° C.), 685° F. (363° C.) and 695° F. (368° C.), respectively. The flow tube connecting the extruder to the die was maintained at 575° F. (302° C.), and the BMF die was maintained at 600° F. (316° C.). The primary air was maintained at about 660° F. (349° C.), and 5.9 psi (40.7 kilopascals (kPa)) with a 0.076 cm gap width, to produce a uniform web. Polypropylene resin (obtained from Total, Houston, Tex.) was delivered from the BMF die (0.6 g/hole/min). The resulting web was collected on a perforated rotating drum collector positioned 7.0 inches (17.8 cm) from the collector. The collector drum was connected to a vacuum system which could be optionally turned on or off while collecting the BMF web, thereby allowing a higher solidity web to be prepared when a vacuum was applied to the collector drum. The BMF webs obtained using this process resulted in a web with a basis weight of 17 g/m² and a fiber EFD of 4.5 microns.

BMF webs were charged using a corona charging process using a drum charger substantially as described in U.S. Pat. No. 4,749,348 (Klaase et al.), which is incorporated herein by reference. Additionally, BMF webs were charged using a hydro-charging process substantially as described in U.S. Pat. No. 5,496,507 (Angadjivand et al.), which is incorporated herein by reference, using a water pressure of about 550 kPa.

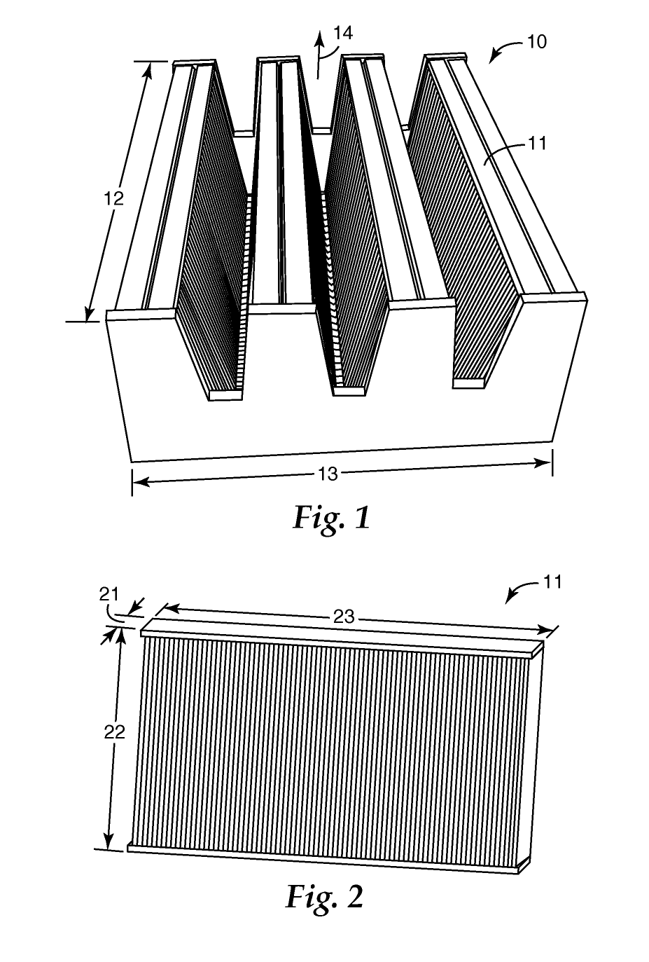

The pleated filter media laminate to be tested (illustrated in FIG. 3) was made by taking nanofibers, 35, (0.25 micron fiber diameter available from Donaldson, St. Paul, Minn., under the trade designation “ULTRAWEB”) and forming it on to a spunbond polyester, 34, (available from Johns Manville under the trade designation J-90; 90 g/m²). The nanofiber filter media was then laminated to polypropylene melt blown microfiber web, 36, ((17 g/m² basis weight and 4.3 micron EFD) described above, with a hot melt adhesive (type sprayed at a basis weight of 8.0 g/m²). A polyester cover web, 37, (available from BBA Fiberweb, Simpsonville, S.C. under the trade designation “REEMAY 2004”; basis weight 14 g/m²) was overlaid on the construction described above. The filter media laminate had a total basis weight of 129 g/m². Referring to FIG. 2, this multilayer laminate was pleated into a pleated filter pleat pack, 11, with a length, 23, of 22.5 inches (57.2 cm) a depth, 22, 11.0 inches (27.9 cm)). Referring to FIG. 3, the filter media had a pleat height, 21, of 1 inch (2.54 cm) and pleat spacing, 31, of 0.2 inch (5 mm). Pleated filter pleat packs were then assembled into multiple V-shaped constructions in a V bank filter, 10, as illustrated in FIG. 1. The V-bank filter has a footprint of length, 12, (24 inch; 61 cm) times width, 13, (24 inch; 61 cm).

The V bank filter described above was installed in an HVAC office building air handling unit and tested in daily use with direction of air flow, 14. At regular time intervals noted below, the V bank filter was removed from the HVAC housing and tested using the following modified ASHRAE Standard 52.2 Minimum Efficiency Reporting Value (MERV) Method to determine lifetime MERV ratings of the V-bank filters.

Air intake was filtered through a filter using a blower motor (7.5 h.p. electric motor, model 57Y29L-F2AYH, available from Toshiba, New York, N.Y.) and blower fan (model IPW-SD-4; 90° takeoff, available from Greenheck, Schofield, Wis.). The filtered air was then directed along a vertically positioned 12 inch diameter (30.5 cm)×72 inch (182 cm) long steel pipe. The pipe was attached to a 90° 12 inch diameter steel elbow joint (21 inch (53.3 cm) radius bend) using band clamps which was then attached to a horizontally disposed 12 inch diameter×84 inch (213 cm) long steel pipe. In the middle of this pipe was a pitot tube array flow control device made by Paragon Controls, Santa Rosa, Calif. This led to another 90° 12 inch (30.5 cm) diameter steel elbow joint with a 21 inch (53.3 cm) radius bend.

The outlet from this elbow lead into a vertically positioned square pyramid steel plenum (6 feet (183 cm) long, 14 inches (35.6 cm)×14 inches (35.6 cm) square at the top and 26 inches (66 cm)×26 inches (66 cm) square at the base). A particle generator, described below, introduced particles flush with the top of the plenum. An upstream particle probe (a 0.5 inch (1.3 cm) inner diameter copper tube with a 90° 6 inch (15 cm) radius bend) was located near the base of the plenum (20 inches (51 cm) from the bottom). The base of the plenum was connected to a 32 inch (81 cm)×32 inch (81 cm) opening, which holds a horizontal plate with a 22.75 inch (58 cm)×22.75 inch (58 cm) opening. A V-bank filter as described in the examples was placed in this opening with the upstream face directed toward the plenum. A particle probe (a 0.5 inch (1.3 cm) inner diameter copper tube with a 90° 6 inch (15 cm) radius bend) was placed 30 inches (76 cm) downstream from the horizontal plate. The particle probe tube was attached to a particle counter (HIAC/Royko, Model 5230, available from Hach Ultra Analytics, Grant's Pass, Oreg.). The particle counter was switched from the upstream probe to the downstream probe through a 90 degree 2-way valve Model 503227L-VTC made by QCI, Tilton, N.H.

The challenge particulate was generated using a particle generator. The solution to be tested was placed in a nebulizer (Collison 6 jet nebulizer, available from BGI Inc., Waltham, Mass.). The nebulizer was attached via a 0.5 inch (1.3 cm) inner diameter copper tube with a 90° 6 inch (15 cm) radius bend to a glass tube drying column (24 inch (61 cm) length×3 inch (7.6 cm)) packed with calcium sulfate (“DRIERITE” 2-5 mm granular; available from Sigma-Aldrich, Milwaukee, Wis.). The drying column was attached via a 0.5 inch (1.3 cm) inner diameter copper tube to a charge neutralizer (16 inches (41 cm) length×3.0 inches (7.5 cm) diameter; 3M Model 3B4G, Maplewood, Minn.). The charge neutralizer was in turn connected flush with the top of the plenum described above via a 0.5 inch (1.3 cm) inner diameter copper tube with a 90° 8 inch (20 cm) radius bend.

### Web 2

### Web Preparation

A polypropylene based blown microfiber (BMF) web was prepared using a melt blowing process similar to that described, for example, in Wente, “Superfine Thermoplastic Fibers,” in Industrial Engineering Chemistry, Vol. 48, pages 1342 et seq (1956) or in Report No. 4364 of the Naval Research Laboratories, published May 25, 1954, entitled “Manufacture of Superfine Organic Fibers” by Wente et al. The extruder had ten temperature control zones that were maintained at 401° F. (205° C.), 450° F. (232° C.), 510° F. (266° C.), 550° F. (288° C.), 610° F. (321° C.), 640° F. (338° C.), 660° F. (349° C.), 680° F. (360° C.), 690° F. (366° C.) and 705° F. (374° C.), respectively. The flow tube connecting the extruder to the die was maintained at 575° F. (302° C.), and the BMF die was maintained at 606° F. (319° C.). The primary air was maintained at about 660° F. (349° C.), and 6.5 psi (44.8 kilopascals (kPa)) with a 0.076 cm gap width, to produce a uniform web. Polypropylene resin (obtained from Total, Houston, Tex.) was delivered from the BMF die (0.6 g/hole/min). The resulting web was collected on a perforated rotating drum collector positioned 10 inches (25.4 cm) from the collector. The collector drum was connected to a vacuum system which could be optionally turned on or off while collecting the BMF web, thereby allowing a higher solidity web to be prepared when a vacuum was applied to the collector drum. The BMF webs obtained using this process resulted in a web with a basis weight of 17 g/m² and a fiber EFD of 4.1 microns.

BMF webs were charged using a corona charging process using a drum charger substantially as described in U.S. Pat. No. 4,749,348 (Klaase et al.), which is incorporated herein by reference. Additionally, BMF webs were charged using a hydro-charging process substantially as described in U.S. Pat. No. 5,496,507 (Angadjivand et al.), which is incorporated herein by reference, using a water pressure of about 550 kPa.

The pleated filter media to be tested (illustrated in FIG. 3) was made and tested as described for Web 1 above.

### Web 3

### Web Preparation

A polypropylene based blown microfiber (BMF) web was prepared using a melt blowing process similar to that described, for example, in Wente, “Superfine Thermoplastic Fibers,” in Industrial Engineering Chemistry, Vol. 48, pages 1342 et seq (1956) or in Report No. 4364 of the Naval Research Laboratories, published May 25, 1954, entitled “Manufacture of Superfine Organic Fibers” by Wente et al. The extruder had ten temperature control zones that were maintained at 401° F. (205° C.), 450° F. (232° C.), 490° F. (254° C.), 540° F. (282° C.), 560° F. (293° C.), 575° F. (302° C.), 615° F. (324° C.), 650° F. (343° C.), 675° F. (357° C.) and 695° F. (368° C.), respectively. The flow tube connecting the extruder to the die was maintained at 575° F. (302° C.), and the BMF die was maintained at 606° F. (319° C.). The primary air was maintained at about 660° F. (349° C.), and 6.5 psi (44.8 kilopascals (kPa)) with a 0.076 cm gap width, to produce a uniform web. Polypropylene resin (obtained from Total, Houston Tex.) was delivered from the BMF die (0.3 g/hole/min). The resulting web was collected on a perforated rotating drum collector positioned 8.5 inches (21.6 cm) from the collector. The collector drum was connected to a vacuum system which could be optionally turned on or off while collecting the BMF web, thereby allowing a higher solidity web to be prepared when a vacuum was applied to the collector drum. The BMF webs obtained using this process resulted in a web with a basis weight of 21 g/m² and a fiber EFD of 3.0 microns.

BMF webs were charged using a corona charging process using a drum charger substantially as described in U.S. Pat. No. 4,749,348 (Klaase et al.) which is incorporated herein by reference. Additionally, the BMF webs were charged using a hydro-charging process substantially as described in U.S. Pat. No. 5,496,507 (Angadjivand et al.), which is incorporated herein by reference, using a water pressure of about 550 kPa.

### Test Methods

### Pressure Drop

The pressure drop of the unpleated filter media and laminates were measured using the following procedure. An 11.5 inch×11.5 inch (29.2 cm×29.2 cm) flat sample of the filter media laminate including that described above was set into a frame and inserted into a housing. The housing was 14 inches×14 inches (35.6 cm×35.6 cm) and two pressure sensors (available from Dwyer Ins, Michigan City, Ind.; 0.0-0.5 particle detection) were located in the housing (4.0 inches (10.2 cm) from each side of the filter media laminate), one on the “upstream” side of the filter media laminate and one on the “downstream” side of the filter media laminate. Additionally, two particle detectors (model 1230; available from HIAC Royco 123, Silver Springs, Md.) were similarly situated (7.0 inches (17.8 cm) from each side of the media laminate and 12 inches (30.5) downstream from the filter media laminate). A laminar flow element (Model 50MC2-2; available from Merriam Instruments, Cleveland, Ohio) was fitted onto the “upstream” side of the filter media laminate (48 inches (122 cm)). Air flow supply from the compressor was set to 30 cubic feet per minute. An aqueous KCl solution (10%) was atomized using an atomizer and a neutralizer (Model 3054; KR-85 TSI Inc, Shoreview, Minn.) to create the small particles. The pressure drop (at 30 feet per minute) of the filter media laminate is measured after 10-15 minutes of running the compressor (Table 1). The small particle (0.3 to 1 micron) efficiency of the filter media laminate was measured by setting the particle detectors according to the manufacturers instructions.

TABLE 1
Flat Media Performance

| | | Pressure Drop | small particle |
|---|---|---|---|
| Example | Media Description | inches (cm) | efficiency (%) |
| Comparative | Filter media | 0.13 (0.33) | 17 |
| Example C-1 | obtained from 3M | | |
| | Company, St Paul, | | |
| | MN under the trade | | |
| | designation | | |
| | “FILTRETE | | |
| | COMMERCIAL | | |
| | HIGH | | |
| | PERFORMANCE | | |
| | HVAC FILTER” | | |
| Comparative | Web 3 | 0.50 (1.27) | 68 |
| Example C-2 | | | |
| Comparative | BMF of Web | 0.28 (0.71) | 52 |
| Example C-3 | 1(17 g/m², EFD 4.5 | | |
| | microns) | | |
| Example 1 | Web 1 | 0.35 (0.90) | 70 |
| Example 2 | Web 2 | 0.29 (0.74) | 72 |
| Comparative | Glassfiber; | 0.50 (1.27) | 71 |
| Example C-1 | “LYDAIR 90-95% | | |
| | ASHRAE” available | | |
| | from Lydall | | |
| | Filtration, | | |
| | Manchester CT | | |

TABLE 2
Comparative Example C-3; Pleated V-bank fresh air
intake filters with BMF media only.

| | | Initial | 960 hr | 1944 hr | 2976 hr | 4488 hr |
|---|---|---|---|---|---|---|
| Pressure | | 0.32 | 0.35 | 0.36 | 0.36 | 0.37 |
| Drop (inch) | | | | | | |
| E1 Efficiency | 0.3-1.0 | 99.57 | 78.78 | 66.12 | 58.09 | 55.53 |
| | micron | | | | | |
| E2 Efficiency | 1.0-3.0 | 99.69 | 93.32 | 91.53 | 89.35 | 90.31 |
| | micron | | | | | |

TABLE 3
Example; Pleated V-bank filter Web 2 media.

| | | Initial | 960 hr | 1944 hr | 2976 hr | 4488 hr |
|---|---|---|---|---|---|---|
| Pressure Drop | | 0.32 | 0.33 | 0.35 | 0.42 | 0.41 |
| (inch) | | | | | | |
| E1 | 0.3-1.0 | 99.63 | 94.35 | 81.40 | 74.99 | 70.45 |
| Efficiency (note | micron | | | | | |
| >75 for MERV | | | | | | |
| 14) | | | | | | |
| E2 | 1.0-3.0 | 99.83 | 98.75 | 95.59 | 94.40 | 93.50 |
| Efficiency (note | micron | | | | | |
| >90 for MERV | | | | | | |
| 14) | | | | | | |

### Web Characterization Procedures

### Web Thickness

The distance between a stainless steel plate and a stainless steel disc (diameter of 3.94 inches (100 mm); 230 g) was measured using a laser displacement sensor (available from IDEC, Sunnyvale, Calif., model number is MX1B-B12R6S). The sensor is a laser displacement sensor that measures the distance from the sensor to the top of the disc. This is the “zero set” value.

The disc was then lifted from the stainless steel plate. The web material to be tested was placed on a stainless steel plate, and a stainless steel disc was placed on the sample being tested, sandwiching the sample between plate and the disc. The laser displacement sensor was used to measure the distance between the sensor and the top of the disc. The web thickness is calculated using the following equation:

(Distance from sensor to disc with sample)−(“zero set” value)=web thickness

### Effective Fiber Diameter (EFD)

The EFD of the melt blown webs is determined according to the method set forth in Davies, C. N.: Proc. Inst. Mech. Engrs., London, 1B, p. 185, (1952).

1. A pleated HVAC filter comprising a pleated filter media laminate of a melt blown nonwoven media containing layer and a nanofiber filter media layer, the melt blown nonwoven media containing layer having an upstream face and a downstream face, where the downstream face is laminated to the nanofiber filter media layer and the melt blown nonwoven media having a basis weight of less than 30 grams/m² and a thickness of less than 1 mm, the filter media laminate having a basis weight of less than 200 grams/m² and a thickness of less than 3 mm where the filter media laminate is pleated to a pleat density of at least 1 pleats/cm and has an initial pressure drop of less than 0.45 inches of water, a small particle efficiency, relative to 0.3 to 1.0 micron particles, of greater than 70 percent, the nanofiber filter media comprising a nanofiber web on a support backing, wherein the nanofibers have a diameter of less than 1.0 microns and an efficiency relative to 0.8 micron PSL particles of greater than 30 percent.

2. The pleated HVAC filter of claim 1 wherein the pleated filter media laminate has a pleat density of from 1 to 5 pleats/cm.

3. The pleated HVAC filter of claim 1 wherein the pleated filter media laminate has a pleat density of from 2 to 5 pleats/cm.

4. The pleated HVAC filter of claim 1 wherein the melt blow nonwoven media is less than 1 mm thick and has an EFD of less than 6 microns.

5. The pleated HVAC filter of claim 5 wherein the melt blow nonwoven media is less than 0.6 mm thick and has an EFD of less than 5 microns.

6. The pleated HVAC filter of claim 5 wherein the melt blow nonwoven media is less than 0.6 mm thick and has a basis weight of less than 20 grams/m².

7. The pleated HVAC filter of claim 2 wherein the filter media laminate has a thickness of less than 3 mm.

8. The pleated HVAC filter of claim 7 wherein the filter media laminate has a thickness of less than 2 mm.

9. The pleated HVAC filter of claim 1 wherein the pleated filter media laminate has a pleat depth of 0.5 to 10 cm.

10. The pleated HVAC filter of claim 9 wherein the pleated filter media laminate has a pleat depth of 1 to 5 cm.

11. The pleated HVAC filter of claim 1 wherein the filter media laminate has an filtration efficiency relative to 0.3 to 1.0 micron particles of greater than 60 percent.

12. The pleated HVAC filter of claim 11 wherein the filter media laminate has an filtration efficiency relative to 0.3 to 1.0 micron particles of greater than 65 percent.

13. The pleated HVAC filter of claim 12 wherein the filter media laminate has an filtration efficiency relative to 0.3 to 1.0 micron particles of greater than 70 percent.

14. The pleated HVAC filter of claim 1 wherein the pleated filter has an overall pressure drop of less than 0.4 inches.

15. The pleated HVAC filter of claim 14 wherein the melt blown filter media has a pressure drop of less than 0.3 inches.

16. The pleated HVAC filter of claim 15 wherein the filter media laminate has a pressure drop of less than 0.45 inches.

17. The pleated HVAC filter of claim 15 wherein the pleated filter has an overall pressure drop of less than 0.35 inches and the filter media laminate has an pressure drop of less than 0.40 inches.

18. The pleated HVAC filter of claim 15 wherein the pleated filter has an overall pressure drop of less than 0.30 inches and the filter media laminate has an pressure drop of less than 0.40 inches.

19. The pleated HVAC filter of claim 17 wherein the melt blown filter media has a basis weight of less than 20 grams/m².

20. The pleated HVAC filter of claim 1 wherein filter has a small particle efficiency, relative to 0.3 to 1.0 micron particles, of greater than 75 percent.

21. The pleated HVAC filter of claim 1 wherein the melt blown filter media is a charged media.

22. The pleated HVAC filter of claim 1 wherein the nanofiber media support is a spunbond web.

23. The pleated HVAC filter of claim 1 wherein the nanofiber media support is a spunbond web having a basis weight of 40 to 150 g/m².

24. The pleated HVAC filter of claim 1 wherein the nanofiber media is formed of fibers having an average diameter of less than 1.0 microns.

25. The pleated HVAC filter of claim 1 wherein the nanofiber media is formed of fibers having an average diameter of less than 0.5 microns, and has a thickness of less than 5 microns.

26. The pleated HVAC filter of claim 1 wherein the melt blown filter media fibers are formed from a nonconductive polyolefin resin or blend.

27. The pleated HVAC filter of claim 1 wherein the melt blown filter media is formed of charged fibers of polypropylene, poly (4-methyl-1-pentene) or blends thereof.

28. The pleated HVAC filter of claim 1 wherein the melt blown filter media further comprises a support web.

29. The high efficiency filter medium of claim 28 wherein the filter medium support web is attached to at least one face of the nonwoven filter web.
